(19) United States
(12) Patent Application Publication
(10) Pub. No.: US 2015/0064307 A1
(43) Pub. Date: Mar. 5, 2015

(54) SLICED, GRATED OR SHREDDED CHEESE AND METHOD FOR THE PRODUCTION THEREOF

(71) Applicant: CSK Food Enrichment B.V., Leeuwarden (NL)

(72) Inventors: Daniël Wagter, Leeuwarden (NL); Cecylia Agnieszka Szewczyk, Coshocton, OH (US); Lourdes Mariela Serrano Davalos, Arnhem (NL); Willem Cornelis Meijer, Bennekom (NL)

(73) Assignee: CSK Food Enrichment B.V., Leeuwarden, (NL)

(21) Appl. No.: 14/390,011

(22) PCT Filed: Apr. 2, 2013
(86) PCT No.: PCT/NL2013/050240

§ 371 Date: Oct. 1, 2014

(30) Foreign Application Priority Data
Apr. 2, 2012 (NL) 2008585

(51) Int. Cl. A23C 19/09; A23C 19/06

(52) U.S. Cl. CPC A23C 19/0908; A23C 19/062; A23C 19/09; A23Y 2240/41; A23Y 2240/75
USPC 426/36; 426/582

(57) ABSTRACT

The invention is concerned with a method for producing a sliced, grated or shredded cheese, wherein the cheese is of the semi-hard or hard type and wherein said cheese is prepared with a starter culture comprising polysaccharide producing lactic acid bacteria. The cheese preferably has a reduced fat content. The sliced or grated cheese advantageously has a reduced tendency to stick or lump together.

### FIELD OF THE INVENTION

The present invention is in the field of cheese in sliced, grated or shredded form and in particular concerns a method for the production thereof and sliced, grated or shredded cheese thus obtained.

### BACKGROUND OF THE INVENTION

Cheese of the semi-hard or hard type is often industrially manufactured in grated, shredded or sliced form in order to meet demands of the final consumer and/or to meet demands of industries using cheese as an ingredient, such as industrial pizza makers.

It is commonly found that cheese slices, when stacked on top of each other, tend to stick together such that at the time the stack of cheese slices reaches the consumer, it is very difficult to take a cheese slice from the stack without damaging it or the underlying slice. At present such sticking problems are solved or at least diminished by separating adjacent cheese slices using sheets of non-dairy based materials which are placed in between said cheese slices. Accordingly physical contact between adjacent slices is prevented or reduced. Said sheets are typically called “interlayers”. Apart from being cumbersome to handle for the producer and the consumer of cheese slices, interlayers generate additional waste.

A similar problem of cheese sticking together occurs with grated or shredded cheese. Especially, after production and packaging, quality controlled grated or shredded cheese tends to form lumps before it is consumed or used further in e.g. covering pizzas. At present such sticking problems are solved by adding anti-caking agents, such as cellulose in powdered form, or calcium phosphates. Also these preventive measures are cumbersome, and the anti-caking additives may reduce the organoleptic quality of the grated or shredded cheese.

EP 639332 discloses a method for preparing a Cheddar type cheese, wherein milk is inoculated with a starter comprising Lactococcus lactis and an EPS-producing culture of S. thermophilus.

### SUMMARY OF THE INVENTION

It is an object of the present invention to at least reduce or preferably prevent the problem associated with sliced, grated or shredded cheese sticking together. It is also an object that the use of interlayers with sliced cheese can be reduced or prevented or that the interlayers for placing in between adjacent cheese slices can preferably be disposed of altogether. Likewise it is an object to reduce or preferably prevent the need for anti-caking agents such as powdered cellulose or calcium phosphates to be added to grated or shredded cheese.

Surprisingly it has been found that including a strain of Streptococcus thermophilus that is capable of producing polysaccharides in the cheese making process results in cheese with improved properties in terms of stickiness when it is sliced or grated. Cheese slices from cheese that is produced in a method that includes Streptococcus thermophilus capable of producing polysaccharides in the starter culture are less sticky compared to slices from cheese produced with the same starter culture in the absence of Streptococcus thermophilus capable of producing polysaccharides. Likewise, grating cheese that is produced in a method that includes Streptococcus thermophilus capable of producing polysaccharides in the starter culture results in grated cheese that forms less lumps compared to grated cheese fom cheese produced with the same starter culture in the absence of Streptococcus thermophilus capable of producing polysaccharides.

Thus the invention concerns a method for producing sliced or grated or shredded cheese, said method comprising including Streptococcus thermophilus capable of producing polysaccharides in the starter culture of a cheese making process known per se and slicing or grating or shredding the cheese that is made.

More in particular, the invention concerns a method for producing cheese in sliced, grated or shredded form comprising:
a. providing milk, a coagulant and a starter culture;
b. mixing the milk, the coagulant and the starter culture and optionally one or more suitable further ingredients to provide a cheese milk composition;
c. allowing the cheese milk composition to curdle, and obtaining curds;
d. pressing the curds in a mould to form a shaped curd mass;
e. allowing the shaped curd mass to ripen during preferably 14 days or longer, more preferably during 27 days or longer, to obtain a cheese of the semi-hard or hard type; and
f1. slicing said cheese, wherein the cheese slices thus obtained are subsequently arranged to provide a stack of at least two cheese slices; or
f2. grating or shredding said cheese;
   wherein the starter culture comprises in addition to a strain of Lactococcus lactis subsp. a strain of Streptococcus thermophilus capable of producing polysaccharides.

In a preferred embodiment, the starter culture further comprises thermophilic lactobacilli. Suitable thermophilic lactobacilli comprise Lactobacillus helveticus and Lactobacillus acidophilus.

It is believed that the invention can be broadened towards any polysaccharide producing strain of lactic acid bacteria. Preferred polysaccharide producing strains of lactic acid bacteria are selected from the group consisting of Lactobacillus subsp. that is capable of producing polysaccharides and Streptococcus subsp. that is capable of producing polysaccharides. Thus in the broadest sense the invention provides a method for producing cheese in sliced form or in grated or shredded form comprising:
a. providing milk, a coagulant and a starter culture;
b. mixing the milk, the coagulant and the starter culture and optionally one or more suitable further ingredients to provide a cheese milk composition;
c. allowing the cheese milk composition to curdle, and obtaining curds;
d. pressing the curds in a mould to form a shaped curd mass;
e. allowing the shaped curd mass to ripen during preferably 14 days or longer, more preferably during 27 days or longer, to obtain a cheese of the semi-hard or hard type; and
f1. slicing said cheese, wherein the cheese slices thus obtained are subsequently arranged to provide a stack of at least two cheese slices; or
f2. grating or shredding said cheese;
   wherein the starter culture comprises a polysaccharide producing strain of a lactic acid bacterium. In the embodiment wherein the starter culture comprises one or more strains capable of producing polysaccharides selected from the group consisting of Lactobacillus subsp. and Streptococcus subsp, the starter culture comprises in addition thereto a strain of Lactococcus lactis subsp.

The polysaccharide producing strain of lactic acid bacteria is preferably capable of growth in, or has metabolic activity in the optionally curdled cheese milk composition during step (b) or (c). In a preferred embodiment, the strain of Lactobacillus subsp. that is capable of producing polysaccharides is a mesophilic strain. Suitable mesophilic lactobacilli that are capable of producing polysaccharides comprise Lactobacillus fermentum. Thus in one embodiment, the strain of lactic acid bacteria capable of producing polysaccharides comprises Lactobacillus fermentum.

### Definitions and Conventions

Streptococcus is a genus of spherical Gram-positive bacteria belonging to the lactic acid bacteria group. The term “Streptococcus thermophilus” is known to the skilled person and is a homofermentative facultative anaerobe of the viridans group. Streptococcus thermophilus is capable (as e.g. in yoghurt production) of synergetic growth with Lactobacillus delbrueckii subsp. bulgaricus. “Streptococcus thermophilus” is equivalent to “Streptococcus salivarius subsp. thermophilus” and vice versa.

Lactobacillus is a genus of Gram-positive facultative anaerobic or microaerophilic rod-shaped bacteria belonging to the lactic acid bacteria group. In the context of this invention preferred Lactobacillus subsp. capable of producing polysaccharides is selected from Lactobacillus delbrueckii subsp. bulgaricus and Lactobacillus fermentum.

The term “polysaccharide” herein comprises “capsular polysaccharide” and “exopolysaccharide”. A capsular polysaccharide (CPS) is an extracellular polysaccharide which is mainly present in the form of a capsule attached to the cell wall and not dissociated from the bacterial cells. By contrast, an exopolysaccharide (EPS) is mainly dissociated from the bacterial cell by which it is produced. The presence of CPS can be demonstrated microscopically using a stain with Indian ink in combination with phase-contrast microscopy. Capsules around bacteria are visible in the preparation as a clear zone around the bacterium, against a brown-black background with particles of Indian ink (Duguid staining method, see Murray, R. G. E., Doetsch, R. N. and Robinow, C. F. “Determinative and cytological light microscopy” in: Methods for general and molecular bacteriology. P. Gerhardt (Ed.) American Society for Microbiology, Washington, 1994, p. 34). Another method of demonstrating capsular polysaccharide is confocal scanning laser microscopy (CSLM, see Hassan, A. N. et at “Observation of encapsulated lactic acid bacteria using confocal scanning laser microscopy.” J. Dairy Sci. 1995, 78, pp. 2624-2628). Isolation and characterisation of bacterial EPS can be carried out utilising conventional (physicochemical) methods. See in this connection: Van Marle and Zoon, Neth. Milk Dairy J. 1995, 49, pp. 47-65. A strain capable of producing exopolysaccharides or equivalently an exopolysaccharide-producing strain, is defined as a bacterial strain which under conditions of optimal growth is able to produce exopolysaccharides. Such bacterial strain preferably has, encoded on its chromosome or on a plasmid, an eps gene cluster essential for exopolysaccharide biosynthesis, such as a gene or gene cluster encoding for glycosyltransferase activity. It is known to the skilled person how to select strains which are capable to produce exopolysaccharides. Preferably, such strains are obtained by growing bacteria on a suitable medium at a suitable temperature of typically between 30-40° C. such as 37° C., removing bacterial cells from the fermentate thus obtained by centrifugation, and adding two volume parts of ethanol to the supernatant at 4° C.; if a precipitate is formed, which after dissolution in water and subsequent dialysis using dialysis tube having a molecular weight cut-off of 10,000 D is shown (for example using nuclear magnetic resonance spectroscopy or size exclusion chromatography) to comprise polysaccharides which do not originate from the medium, the strain is capable of producing exopolysaccharides. The amount of exopolysaccharides produced is preferably determined as polysaccharides which do not originate from the medium and is preferably established as the dry weight of the fraction isolated by the above-mentioned procedure comprising ethanol precipitation and subsequent dialysis the supernatant of the medium incubated with the exopolysaccharide-producing strain, minus the dry weight of the fraction isolated by ethanol precipitation and subsequent dialysis under the same conditions of the supernatant of a same volume of the non-incubated freshly prepared sterile medium. The concentration of exopolysaccharides produced by the strain in the medium is preferably at least 1 mg/litre, more preferably at least 5 mg/litre, most preferably at least 15 mg/litre such as at least 20 mg/litre, 50 mg/litre or at least 100 mg/litre. The concentration of exopolysaccharides produced by the strain in the medium is preferably not more than 5000 mg/litre, otherwise the consistency of the cheese may become too soggy.

The polysaccharide producing strain preferably produces polysaccharides having a weight-averaged molecular weight lower than 10⁹ g/mol, more preferably from 1.10⁴ to 5.10⁸ g/mol. The polysaccharide producing strain preferably produces exopolysaccharides having a weight-averaged molecular weight lower than 10⁹ g/mol, preferably from 1.10⁴ to 5.10⁸ g/mol. Without being bound to theory, it is believed that the water binding capacitiy of the polysaccharide may be an important factor in reducing stickiness of cheese. Model experiments on cheese slices have shown that if the polysaccharide is an exopolysaccharide having a very high molecular weight, the desired effect of reducing stickiness may be reduced, possibly because of entanglements of exopolysaccharides occurring between adjacent slices of cheese. Furthermore it was suggested that a high exopolysaccharide producing capability (in terms of concentrations produced by the strain in the medium, supra) may contribute to enhancing water binding capacity and thereby to further reduce stickiness between sliced cheese. It is especially preferred that the exopolysaccharide-producing strain is capable of exopolysaccharides when grown on milk, especially on cow's milk, sheep milk, goat milk, or a mixture thereof

The expression “cell count” is known to the skilled person and relates to the number of colony forming units (cfu) identifiable on an agar plate comprising a suitable growth medium, per gram of the composition from which the corresponding bacteria originate. For starter cultures, cell count is suitably expressed as cfu/g or as cfu/ml. Suitable media for cell counting are known to the skilled person. For example, a preferred medium for plating out lactococci is M17 agar preferably as described in Terzaghi and Sandine, Appl. Microbiol. 1975, 29, 807-813. Strains of Lactococcus lactis subsp. lactis biovar. diacetylactis and of Leuconostoc subsp. can be collectively counted using WACCA agar preferably as described in Galesloot et al., Neth. Milk Dairy J. 1961, 15, pp. 127-150. Leuconostoc subsp. can be selectively counted using said WACCA agar supplemented with an amount of vancomycin which is inhibitory to lactococci but not to Leuconostoc subsp. Total count of lactococci and of Leuconostoc subsp. is determined as the sum of count on M17 and count on WACCA supplemented with vancomycin. A preferred medium for plating out Lactobacilli is MRS (De Man, Rogosa and Sharpe J Appl. Bact. 1960, 23 130-135). A preferred medium for selective counting of yeasts and moulds is Oxytetracycline Glucose Yeast Extract (OGY) Agar preferably as described in Mossel et al. J Appl. Bact. 1970, 33, 454-457. The total count of the starter culture is preferably determined on PCA (plate count agar) which preferably comprises 0.5% peptone, 0.25% yeast extract, 0.1% glucose and 1.5% agar; pH adjusted to neutral. Strains of Streptococcus thermophilus are preferably counted on ST agar as described in Dave and Shah, J. Dairy Sci. 1996, 79, 1529-1536.

The expression “pellet” or “frozen pellet” herein is known to the person skilled in the art of producing fermented dairy products, and refers to small solid entities of frozen liquid having an average size of preferably between 0.1 to 10 mm. A starter culture in the form of frozen pellets may conveniently be made by adding the starter culture drop wise into liquid nitrogen.

The expression “mesophilic bacteria” relates to bacteria having an optimal growth temperature of between 15-33° C. Thermophilic bacteria have a higher optimal growth temperature than mesophilic bacteria; the optimal growth temperature of thermophilic bacteria preferably ranges between 37 and 50° C.

The expression “lactic acid bacteria” is known to the skilled person and relates to Gram-positive bacteria capable of producing lactic acid, under anaerobic conditions, as the major metabolic end-product of carbohydrate fermentation. Preferably the expression “lactic acid bacteria” comprises a bacterial subspecies from one or more genera selected from the group consisting of Lactobacillus, Leuconostoc, Pediococcus, Lactococcus, Streptococcus, Aerococcus, Carnobacterium, Enterococcus, Oenococcus, Sporolactobacillus, Tetragenococcus, Vagococcus and Weisella.

The expression “dried” herein preferably relates to freeze-dried or spray-dried. A dried starter culture is reconstitutable in an aqueous liquid.

In this document and in its claims, the verb “to comprise” and its conjugations is used in its non-limiting sense to mean that items following the word are included, but items not specifically mentioned are not excluded. In addition, reference to an element by the indefinite article “a” or “an” does not exclude the possibility that more than one of the element is present, unless the context clearly requires that there be one and only one of the elements. The indefinite article “a” or “an” thus usually means “at least one”.

### DETAILED DESCRIPTION OF THE INVENTION

### Cheese in Grated or Shredded Form

In one embodiment the invention concerns a method for producing cheese in grated or shredded form that is packaged. Preferably after ripening of the cheese, the cheese is grated or shredded and more preferably the grated or shredded cheese is packaged in a container that contains about at least 25 g grated or shredded cheese.

Thus, more specifically, the invention concerns a method for producing packaged grated or shredded cheese comprising:
a. providing milk, a coagulant and a starter culture;
b. mixing the milk, the coagulant and the starter culture and optionally one or more suitable further ingredients to provide a cheese milk composition;
c. allowing the cheese milk composition to curdle, and obtaining curds;
d. pressing the curds in a mould to form a shaped curd mass;
e. allowing the shaped curd mass to ripen during preferably 14 days or longer, more preferably during 27 days or longer, to obtain a cheese of the semi-hard or hard type; and
f. grating or shredding said cheese;
   wherein the grated or shredded cheese thus obtained is packaged in a container that contains about at least 25 g grated or shredded cheese, and wherein the starter culture comprises one or more lactic acid bacterial strains capable of producing polysaccharides. The one or more lactic acid strains capable of producing polysaccharides are preferably selected from the group consisting of Lactobacillus subsp. and Streptococcus subsp. It is especially preferred that the one or more lactic acid bacterial strains capable of producing polysaccharides comprise a strain of Streptococcus thermophilus capable of producing polysaccharides and that the starter culture in this embodiment further comprises a strain of Lactococcus lactis subsp.

In one embodiment the container contains about at least 50 g grated or shredded cheese, preferably about at least 75 g, preferably about at least 100 g, preferably about at least 150 g, preferably about at least 200 g, preferably about at least 250 g, preferably about at least 300 g or more of grated cheese. In an especially preferred embodiment the container contains between 500 g and 25 kg of grated or shredded cheese. Such containers are typically used in an industrial environment, e.g. for storing grated or shredded cheese to be used in the pizza making industry. Such large quantities of prior art grated or shredded cheese tend to clump easily under the influence of gravity, however grated or shredded cheese obtained according to the invention will be less prone to clumping even when contained in such large amounts.

Suitable containers are those that are commonly applied for containing grated cheese and that are known per se in the art. In one embodiment, the container is a plastic bag.

The invention also provides packages of grated or shredded cheese obtainable by the present method

### Cheese in Sliced Form

In one embodiment the invention concerns a method for producing cheese in sliced form, and preferably for producing a stack of at least two cheese slices.

More specifically, the invention concerns a method for producing a stack of at least two cheese slices comprising:
a. providing milk, a coagulant and a starter culture;
b. mixing the milk, the coagulant and the starter culture and optionally one or more suitable further ingredients to provide a cheese milk composition;
c. allowing the cheese milk composition to curdle, and obtaining curds;
d. pressing the curds in a mould to form a shaped curd mass;
e. allowing the shaped curd mass to ripen during preferably 14 days or longer, more preferably during 27 days or longer, to obtain a cheese of the semi-hard or hard type; and
f. slicing said cheese;
   wherein the cheese slices thus obtained are subsequently arranged to provide a stack of at least two cheese slices; and wherein the starter culture comprises one or more lactic acid bacterial strains capable of producing polysaccharides. The one or more lactic acid bacterial strains capable of producing polysaccharides are preferably selected from the group consisting of Lactobacillus subsp. and Streptococcus subsp. It is especially preferred that the one or more lactic acid bacterial strains capable of producing polysaccharides comprise a strain of Streptococcus thermophilus capable of producing polysaccharides and that the starter culture in this embodiment further comprises a strain of Lactococcus lactis subsp.

Preferably the method further comprises packaging the stack at least two cheese slices. The stack of cheese slices can be suitably packaged, for example flow wrapped. The invention also provides a stack of at least two cheese slices obtainable by the present method.

Preferably the stack comprises more than 2 cheese slices, preferably the stack comprises at least 3 cheese slices, or at least 4 or 5 or 6 or 7 or 8 or 9 or 10 or 11 or 12 or 13 or 14 or 15 or 16 or 17 or 18 or 19 or 20 or more such as at least 25 or 30 or 40 or at least 50 cheese slices. Preferably the stack comprises less than 100 cheese slices.

### Fat Content and Type of Milk

The milk that is provided in step a. preferably has a fat content of 2.5 wt. % or lower, more preferably of 2.0 wt. % or lower, most preferably of 1.6 wt. % or lower such as 1.0 wt. % or lower or 0.5 wt. % or lower. It is preferred that no further fat sources are added to the milk, or that further fat sources are added to the milk in an amount which is low enough to increase the total fat content of the cheese obtained by not more than 5 gram of fat per kg of cheese. Herein, the expression “fat” comprises any vegetable or animal fat or oil. Accordingly, a semi-hard or hard cheese can be produced preferably having a fat content of 40 wt. % or lower, more preferably of 38 wt. % or lower, most preferably of 35 wt. % or lower, such as: 30 wt. % or lower, 25 wt. % or lower, 20 wt. % or lower or 15 wt. % or lower, wherein the weight percentage is calculated relative to the dry weight of the cheese. It has been found that the lower the fat content of a cheese prepared without the added lactic acid bacterial strain capable of producing polysaccharides, the higher the tendency of cheese slices to stick to each other when stacked on top of each other and of and of grated cheese to stick together and form lumps. However even when such cheese having a reduced fat content is prepared according to the method of the invention, the sticking problem can be reduced or prevented by employing the lactic acid bacterial strain capable of producing polysaccharides. The milk preferably comprises cow's milk, sheep milk, goat milk or a mixture thereof.

### Coagulant

The coagulant provided in step a. preferably comprises an enzyme capable of clotting milk. Said enzyme is preferably capable to cleave of a single 105-Ser-Phe-|I-Met-Ala-108 bond in the kappa-chain of casein. A preferred enzyme capable of clotting milk is chymosin (obtainable as so-called fermentation produced chymosin, or more preferably obtainable by extraction of the abomasum of a calf). Alternatively or additionally the coagulant may comprise microbial rennet. Microbial rennet is a peptidase composition obtained by fermentation of a fungal strain which is preferably selected from the group consisting of Endothia parasitica, Rhizomucor pusillus and Rhizomucor miehei. Thus, the coagulant is preferably defined as a composition comprising enzymes capable of clotting milk, said enzymes preferably being chosen as one or more compounds selected from the group consisting of chymosin and a milk clotting peptidase obtainable by fermentation of a fungal strain selected from the group consisting of Endothia parasitica, Rhizomucor pusillus and Rhizomucor miehei.

### Starter Culture

The starter culture provided in step a. preferably contains a strain of Lactococcus lactis subsp. Such strains are commonly employed in starter cultures in cheese making processes and are known to work well together with strains of Streptococcus thermophilus. The strain of Lactococcus lactis subsp preferably comprises a strain of Lactococcus lactis subsp. lactis and preferably further a strain of Lactococcus lactis subsp. cremoris. The starter culture preferably further comprises a strain of Lactococcus lactis subsp. lactis biovar. diacetylactis, or a strain of Leuconostoc subsp., or a mixture of both. If present, the total count of Leuconostoc subsp. in the starter culture is preferably at least 1.10⁸ cfu/g, more preferably at least 5.10⁸ cfu/g, most preferably 1.10⁹ cfu/g relative to the weight of the starter culture. The starter culture preferably comprises a total of lactococci of at least 1.10⁹ cfu/g, more preferably at least 5.10⁹ cfu/g, most preferably 1.10¹⁰ cfu/g relative to the weight of the starter culture.

In one embodiment, the polysaccharide producing lactic acid bacterial strain comprised in the starter culture produces capsular polysaccharides.

In one embodiment, the polysaccharide producing lactic acid bacterial strain comprised in the starter culture produces exopolysaccharides.

In an embodiment the starter culture comprises a strain of Lactobacillus subsp. capable of producing polysaccharides and a strain of Streptococcus subsp. capable of producing polysaccharides, preferably the starter culture comprises a strain of Lactobacillus subsp. capable of producing polysaccharides and a strain of Streptococcus thermophilus capable of producing polysaccharides. In an embodiment, the starter culture comprises a strain of Lactobacillus subsp. capable of producing polysaccharides selected from Lactobacillus delbrueckii subsp. bulgaricus and Lactobacillus fermentum and a strain of Streptococcus subsp. capable of producing polysaccharides, preferably the starter culture comprises a strain of Lactobacillus subsp. capable of producing polysaccharides selected from Lactobacillus delbrueckii subsp. bulgaricus and Lactobacillus fermentum and a strain of Streptococcus thermophilus capable of producing polysaccharides.

It is especially preferred that the polysaccharide producing lactic acid bacterial strain comprised in the starter culture comprises a strain of Streptococcus thermophilus capable of producing exopolysaccharides. The strain of Streptococcus thermophilus capable of producing exopolysaccharides is preferably capable of producing exopolysaccharides having a weight-averaged molecular weight which is lower than 10⁹ g/mol, preferably from 1.10⁴to 5.10⁸ g/mol. Without being bound to theory, it is believed that the water binding capacitiy of the polysaccharide may be an important factor in reducing stickiness of cheese. If the polysaccharide is an exopolysaccharide having a very high molecular weight, the desired effect of reducing stickiness may be reduced, possibly because of entanglements of exopolysaccharides occurring between adjacent slices of cheese. Furthermore a high exopolysaccharide producing capability (in terms of concentrations produced by the strain in the medium, supra) may contribute to enhancing water binding capacity and thereby to reduce stickiness between sliced cheese.

In one aspect of the invention, the starter culture comprises, besides a strain of Lactococcus lactis subsp. and a strain of Streptococcus thermophilus capable of producing polysaccharides, thermophilic lactobacilli. In a preferred embodiment, the thermophilic lactobacilli comprise lactobacilli selected form the group consisting of Lactobacillus helveticus and Lactobacillus acidophilus.

Preferably the starter culture comprises the lactic acid bacteria capable of producing polysaccharides in a total count of 1.10⁶ cfu/g or higher, more preferably 1.10⁷ cfu/g or higher, most preferably 1.10⁸ cfu/g such as 1.10⁹ cfu/g or most preferably at 5.10⁹ cfu/g such as 1.10¹⁰ cfu/g or higher, with respect to the weight of the starter culture.

The invention especially preferably concerns a method for producing a stack of at least two cheese slices comprising:
a. providing milk, a coagulant and a starter culture;
b. mixing the milk, the coagulant and the starter culture and optionally one or more suitable further ingredients to provide a cheese milk composition;
c. allowing the cheese milk composition to curdle, and obtaining curds;
d. pressing the curds in a mould to form a shaped curd mass;
e. allowing the shaped curd mass to ripen during preferably 14 days or longer, more preferably during 27 days or longer, to obtain a cheese of the semi-hard or hard type; and
f. slicing said cheese;
   wherein the cheese slices thus obtained are subsequently arranged to provide a stack of at least two cheese slices, e.g. of between 3-25 slices; and wherein the starter culture comprises a strain of Streptococcus thermophilus capable of producing polysaccharides, a strain of Lactococcus lactis subsp. and thermophilic lactobacilli, wherein the thermophilic lactobacilli preferably comprise one or more strains selected from the group consisting of Lactobacillus helveticus and Lactobacillus acidophilus. Accordingly, an optimal combination can be achieved regarding acidification speed, organoleptic properties and non-sticking properties of the sliced cheese. Herein, the total count of thermophilic lactobacilli in the starter culture is preferably at least 1.10⁸ cfu/g, more preferably at least 5.10⁸ cfu/g, most preferably 1.10⁹ cfu/g relative to the weight of the starter culture; the total count of Streptococcus thermophilus capable of producing polysaccharides in the starter culture is preferably 1.10⁶ cfu/g or higher, more preferably 1.10⁷ cfu/g or higher, most preferably 1.10⁸ cfu/g such as 1.10⁹ cfu/g or most preferably at 5.10⁹ cfu/g such as 1.10¹⁰ cfu/g or higher, with respect to the weight of the starter culture.

It is preferred that the total count of bacteria comprised by the starter culture provided in (a.) is at least 70%, more preferably at least 80%, most preferably at least 90% or even at least 95% accounted for by lactic acid bacteria, especially by bacteria selected from the group consisting of Streptococcus subsp., Lactobacillus subsp. Lactococcus subsp. and Leuconostoc subsp. Additionally or alternatively the starter culture comprises a total of mesophilic lactococci of at least 1.10⁹ cfu/g, more preferably at least 5.10⁹ cfu/g, most preferably 1.10¹⁰ cfu/g relative to the weight of the starter culture.

The dosage of the starter culture can be chosen without inventive effort. Preferably, when inoculating sterilised cow's milk with the starter culture, the dosage of the starter culture is such that the starter culture is capable of reducing the pH of said milk by at least 1.5 pH units within 16 hours after inoculation, the inoculation temperature being set at 30° C.

### Further Ingredients

It is preferred that the one or more suitable further ingredients defined in (b.) are chosen as one or more ingredients selected from the group consisting of a calcium salt, a nitrate salt, and a colorant such as annatto or beta-carotene.

### Mixing and Obtaining Curds

Mixing of the milk, the coagulant and the starter culture and optionally one or more suitable further ingredients to provide a cheese milk composition is carried out as commonly known and applied in cheese making processes. Further as is commonly known, the cheese milk composition is allowed to curdle and curds are obtained. Then following commonly known procedures in cheese making processes, the curds are pressed in moulds whereby a shaped curd mass is obtained.

### Salting

Prior to ripening, the shaped curd mass formed in (d.) is preferably salted by immersion of the shaped curd mass in brine. Brine is an aqueous solution comprising sodium chloride in a concentration of preferably 15-20 wt. % relative to the weight of the aqueous solution. The pH of the brine is preferably between 4.2 and 5.0.

Additionally or more preferably alternatively, the shaped curd mass formed in (d.) may be provided with a sodium chloride content by adding sodium chloride to the curds obtained in an earlier step.

### Ripening

Following formation of a shaped curd mass, after the optional salting step, the shaped curd mass is allowed to ripen. This process step is also commonly known to the skilled person. The shaped curd mass usually is allowed to ripen during preferably 14 days or longer, more preferably during 27 days or longer, to obtain a cheese of the semi-hard or hard type.

### Slicing, Grating or Shredding

Slicing, grating or shredding of the semi-hard or hard cheese conveniently occurs according to methods known in the art. Conveniently, sliced, grated or shredded cheese is obtained from semi-hard or hard cheese in the form of a cheese wheel or in the form of a rectangular block.

### The Cheese

The sliced, grated or shredded cheese obtained in (f) preferably has a fat content of 40 wt. % or lower, more preferably of 38 wt. % or lower, most preferably of 35 wt. % or lower, such as: 30 wt. % or lower, 25 wt. % or lower, 20 wt. % or lower or 15 wt. % % or lower, wherein the weight percentage is calculated relative to the dry weight of the cheese.

It is especially preferred that the grated or shredded cheese comprises an added anti-caking agent in an amount of less than 0.5 wt. %, yet more preferably less than 0.1 wt. % or even less than 0.05 wt. % relative to the total weight of the cheese. The anti-caking agent herein preferably comprises powdered cellulose or a calcium phosphate. In an especially preferred embodiment the surface of the grated or shredded cheese is essentially free of added powdered cellulose or of added calcium phosphate.

It is especially preferred that the cheese slices are not kept at least partly separated from each other by a sheet of a non-dairy based material, such as a paper or plastic sheet.

### Special Embodiments of the Cheese Slices Comprised by the Stack

The stacked cheese slices preferably each have a weight of 5-100 gram, more preferably of 10-50 gram, most preferably of 15-40 gram. Along a first direction, the slices preferably each have a largest dimension of 6-40 cm (i.e. the length). It is possible to define a second direction which is substantially orthogonal to the first direction (i.e. the width). Along this second direction, the slices preferably each have a dimension of 5-30 cm. Preferably the lengths of two adjacent slices in the stack differ from each other by no more than 20% more preferably by no more than 10%.

Preferably the widths of two adjacent slices in the stack differ from each other by no more than 20% more preferably by no more than 10%. The dimension measured along the second direction can be equal to or smaller than the longest dimension measured along the first direction. The first and second directions are established in a plane which is parallel to a slicing plane.

Preferably each of the cheese slices in the stack individually have an average thickness of 0.2-3 mm, more preferably of 0.3-2 mm. It is further preferred that for each individual slice in the stack, the thickness determined at each position within said slice ranges between 0.2-3 mm, more preferably of 0.3-2 mm. The thickness is preferably substantially uniform throughout the slices, preferably meaning that for each slice the thickness determined at each position within said slaid may deviate from the average thickness of said slide by no more than 50%. The thickness is defined as the smallest dimension of the cheese slices and the thickness is preferably determined in a direction which is substantially orthogonal to a slicing plane.

The slices have a first and a second face, each of which lie parallel to a slicing plane. For example, the first face may be oriented up and the second face may be oriented down. If the thickness of a slice is perfectly uniform, the first and the second face will be entirely parallel to each other. The first and the second face each have a certain area. It is understood in that in the stack, by definition, a first face of a first cheese slice is in physical contact with a second face of a second cheese slice adjacent to the first cheese slice. Preferably at least 50% of the area of the first face of the first cheese slice is in physical contact with at least 50% of the area of the second face of the second cheese slice. More preferably at least 70% of the area of the first face of the first cheese slice is in physical contact with at least 70% of the area of the second face of the second cheese slice. Most preferably at least 90% of the area of the first face of the first cheese slice is in physical contact with at least 90% of the area of the second face of the second cheese slice. It is especially preferred that the cheese slices are stacked without substantial translation to each other with respect to a slicing plane.

It is especially preferred that the cheese slices are not kept at least partly separated from each other by a sheet of a non-dairy based material, such as a paper or plastic sheet.

### Providing the Starter Culture

The starter culture is preferably provided in frozen or dried form. It is especially preferred that the polysaccharide-producing lactic acid bacteria are provided as frozen pellets. Also the optional thermophilic lactobacilli are preferably provided as frozen pellets.

### Further Embodiments

The invention further provides the use of a starter culture comprising one or more strains capable of producing polysaccharides for i) reducing or preventing sticking or lumping together of grated or shredded cheese, or ii) reducing or preventing sticking together of stacked cheese slices, wherein the cheese is of the semi-hard or hard type obtained in a cheese making process using said starter culture.

The invention especially provides the use of a starter culture comprising one or more strains capable of producing polysaccharides selected from the group consisting of Lactobacillus subsp. and Streptococcus subsp for i) reducing or preventing sticking or lumping together of grated or shredded cheese, or ii) reducing or preventing sticking together of stacked cheese slices, wherein the cheese is of the semi-hard or hard type obtained in a cheese making process using said starter culture.

In a particularly preferred embodiment the invention provides the use of a starter culture comprising a strain of Streptococcus thermophilus capable of producing polysaccharides for i) reducing or preventing sticking or lumping together of grated or shredded cheese, or ii) reducing or preventing sticking together of stacked cheese slices, wherein the cheese is of the semi-hard or hard type obtained in a cheese making process using said starter culture. The starter culture preferably further comprises a strain of Lactococcus lactis subsp. More preferably, the strain of Lactococcus lactis subsp. comprises a strain of Lactococcus lactis subsp. lactis and even more preferably further a strain of Lactococcus lactis subsp. cremoris. Preferably the starter culture comprises a total of mesophilic lactococci of at least 1.10⁹ cfu/g, more preferably at least 5.10⁹ cfu/g, most preferably 1.10¹⁰ cfu/g relative to the weight of the starter culture. Herein, the starter culture preferably even further comprises thermophilic lactobacilli.

In alle embodiments described above, the Streptococcus thermophilus capable of producing polysaccharides is preferably selected form S700 and S400. S700 and S400 are product names of single cell Streptococcus thermophilus cultures marketed by CSK Food Enrichment B.V.

### EXAMPLES

### 1. Preparation of 30+Gouda-Type Cheese.

30⁺Gouda-type cheese blocks (15 kg weight, Euroblock-type) were prepared according to a standard protocol for Gouda, substantially as described in FIG. 1 of Cheese: Chemistry, Physics and Microbiology (3^{rd} Ed.), Volume 2, P. F. Fox et al. (eds.), p. 106. No bactofugation was applied and instead of using 0.6% v/v with respect to the volume of the milk of a conventional LD-type bulk starter such as CO2 (ex CSK Food Enrichment), the following starter culture was used (for inoculation of 12,000 litres of pasteurised milk having a fat content of 1.6 wt. %): U102 (610 g), S700 (250 g) and L100 (250 g). Herein U102 is a mixed starter culture provided as frozen pellets, comprising multiple strains of Lactococcus lactis subsp. lactis, Lactococcus lactis sub sp. cremoris, Leuconostoc sub sp. and EP S-producing Streptococcus thermophilus. The cell count of the mesophilic lactococci and of the Leuconostoc subsp. together in U102 was 4.10¹⁰ cfu/g with respect to the weight of the frozen pellets. The cell count of S. thermophilus in U102 was 5.10⁹ cfu/g with respect to the weight of the frozen pellets. S700 is a starter culture provided as frozen pellets comprising EPS-producing bacteria of S. thermophilus at a total cell count of about 5.10¹⁰ cfu/g with respect to the weight of the frozen pellets. L100 is a starter culture provided as frozen pellets comprising thermophilic lactobacilli at a total cell count of about 3.10¹⁰ cfu/g with respect to the weight of the frozen pellets. U102, 5700 and L100 are commercially available ex CSK Food Enrichment BV, The Netherlands. Model experiments inter alia measuring peel force between slices suggest that S700 can be favourably replaced by S400. S400 is also a starter culture provided as frozen pellets comprising EPS-producing bacteria of S. thermophilus and S400 is also commercially available ex CSK Food Enrichment BV, The Netherlands.

As coagulant, calf rennet was applied (at 150 IMCU, dosage of 0.02% (v/v) with respect to the milk). Such rennet is commercially available as e.g. Kalase® from CSK Food Enrichment BV.

After pressing the curds in a mould, the shaped curd mass obtained was brined for 5 days and directly afterwards analysed. The water content was 50%, the fat content was 32 wt. % relative to the dry weight of the cheese, the salt content was 4.5 wt. % relative to the dry weight of the cheese.

The brined shaped curd mass was sealed into a conventional thermo-shrinking ripening bag of the cryovac type and allowed to ripen for 28 days at a temperature of 7° C.

The ripening foil was then removed from the cheese and the cheese was cut in slices having a thickness of 1 mm and having a weight of 25 g. 20 slices were put on top of each other to form a stack; no interlayers were applied between the slices. The stack was packaged in a protective atmosphere and left at 4° C. for 1 week. After removing the stack from the package all slices could be separated from each other without any problem or without damaging the slices.

By contrast, in a similar stack comprising cheese slices having the same fat content but being obtained in a conventional cheese making process—employing instead of the starter composition comprising the EPS-producing strain of S. thermophilus only the conventional bulk starter comprising mesophilic lactococci and strains of Leuconostoc subsp. in the same dosage of 0.6% v/v/ with respect to the volume of the cheese milk, wherein the bulk starter is preferably CO2 (ex CSK Food Enrichment BV)—the slices on both ends of the stack could be separated only with difficulty, and slices in the middle of the stack could not be separated from each other without being torn or damaged in another way.

Note: The dosage of the bulk starter herein refers to the dosage of a composition obtained by culturing a mother culture in milk to obtain a bulk starter according to means known in the art. The mother culture and the bulk starter obtained from said mother culture are commonly indicated by the trade name of the mother culture, in casu CO2. U102 and S700 which are provided as pellets are dosed directly into the cheese vat, without pre-culturing in milk.

### 2. Preparation of 20+Gouda-Type Cheese.

12 kg Gouda cheese wheels having a fat content of 20 wt. % relative to the dry weight of the cheese was prepared using milk having a fat content of 1.0 wt. % relative to the total weight of the milk.

A similar recipe was employed as in Example 1. The following starter cultures however were employed:

Variant 1—comparative: the starter culture consisted of bulk starter CO2 (ex CSK Food Enrichment BV), at a dosage of 0.4% (v/v with respect to the volume of the milk) (as freshly prepared bulk starter culture), in combination with 0.02% (v/v with respect to the volume of the milk) of L100 as adjunct culture in the form of frozen pellets. L100 comprises thermophilic lactobacilli.

Variant 2—according to the invention: as variant 1, the starter culture further comprising 0.003% of S700 as a further adjunct culture.

For both variants. As coagulant, microbial rennet was applied (at 750 IMCU, dosage of 0.06% (v/v) with respect to the milk). Such rennet is commercially available as e.g. Milase® XQL from CSK Food Enrichment BV.

After pressing the curds in a mould, the shaped curd mass obtained was brined for 4 days.

The brined shaped curd mass was ripened for 3 months at a temperature of 13 ° C. and at a relative humidity of 88%. During the ripening time, a plastic coating (Ceska WL 200.03.45 ex CSK Food Enrichment BV. The Netherlands) was applied to the exposed top half surface of the cheese following which the coated cheeses were allowed to dry and then turned onto the other side. This coating—drying—turning procedure was repeated several times at time intervals of 1-3 days during the first 14 days of ripening and 2-6 days thereafter according to an established protocol for providing natural ripened Gouda-type cheese.

The flat cylindrical cheese having a dimension of approx. 35 cm (diameter) and 12 cm (height) was cut in four equal pieces by making two orthogonal cuts through the height of the cheese. From one quarter, 8 slices are cut having a thickness of 1 mm, having a largest dimension of 17.5 cm and having a dimension of 12 cm in the dimension orthogonal to the direction in which the largest dimension was measured and measured in a plane which is orthogonal to the thickness of the slice (i.e. in the plane of cutting). The slices when cut are put on top of each other to form a stack; without interlayers between the slices. The faces of two adjacent slices are for more than 95% in physical contact with each other. The stack is packaged in a protective atmosphere and left at 4° C. for 1 week.

One quarter is grated and the grated cheese is packaged in plastic bags. One quarter is shredded and the shredded cheese is packaged in plastic containers.

3. Proof of Principle for further Polysaccharide Producing Strains

As a proof of principle, 20+ Gouda-type cheeses were prepared using S400 or Lactobacillus fermentum as polysaccharide producing strains as further adjunct cultures in the same manner as in exmaple 2. Of the obtained cheese slices were cut and stacked and similar or even less force was needed to peel slices from one another than was needed for the cheese prepared with S700.

1-18. (canceled)

19. A method for producing cheese in sliced, grated or shredded form, comprising:
a. mixing milk, coagulant and starter culture and optionally one or more suitable further ingredients, to provide a cheese milk composition;
b. allowing the cheese milk composition to curdle to obtain curds;
c. pressing the curds in a mould to form a shaped curd mass;
d. allowing the shaped curd mass to ripen to obtain a cheese of the semi-hard or hard type; and, optionally,
e1. slicing the cheese, wherein the cheese slices thus obtained are subsequently arranged to provide a stack of at least two cheese slices; or
e2. grating or shredding the cheese;
wherein the starter culture comprises a strain of Lactococcus lactic subsp. and a strain of Streptococcus thermophilus capable of producing polysaccharides.

20. The method according to claim 19, wherein the shaped curd mass is allowed to ripen for at least 14 days.

21. The method according to claim 19 wherein the cheese has a fat content of 40 wt. % or less relative to the dry weight of the cheese.

22. The method according to claim 19 wherein the cheese has a fat content of 20 wt. % or less relative to the dry weight of the cheese.

23. The method according to claim 19, wherein the strain of Lactococcus lactis subsp. comprises a strain of Lactococcus lactis subsp. lactis and optionally a further a strain of Lactococcus lactis subsp. cremoris.

24. The method according to claim 19, wherein the starter culture comprises a total count of mesophilic lactococci of at least 1.10⁹ cfu/g relative to the weight of the starter culture.

25. The method according to claim 19, wherein the starter culture further comprises thermophilic lactobacilli.

26. The method according to claim 19, wherein the starter culture comprises 1.10⁶ or more Streptococcus thermophilus cfu/g with respect to the weight of the starter culture.

27. The method according to claim 19, wherein the starter culture is provided in frozen or dried form.

28. The method according to claim 19, wherein the further ingredients are chosen as one or more ingredients selected from the group consisting of a calcium salt, a nitrate salt, and a colorant.

29. The method according to claim 28, wherein the colorant comprises annatto or beta-carotene.

30. A stack of at least two cheese slices obtainable by the method according to claim 19, wherein the cheese slices have a fat content of 40 wt. % or less, relative to the dry weight of the cheese.

31. The stack according to claim 30, wherein the cheese slices are not kept at least partly separated from each other by a sheet of a non-dairy based material.

32. The stack according to claim 30, wherein each slice has a first face, a second face and an edge, wherein a first face of a first cheese slice is in physical contact with a second face of a second cheese slice adjacent to the first cheese slice.

33. The stack according to claim 30, wherein at least 50% of the area of the first face of the first cheese slice is in physical contact with at least 50% of the area of the second face of the second cheese slice.

34. The stack according to claim 30, wherein the cheese slices are stacked without substantial translation to each other with respect to a plane of a slice.

35. A grated or shredded cheese obtainable by the method according to claim 19, wherein the grated or shredded cheese has a fat content of 40 wt. % or less, relative to the dry weight of the cheese.

36. The grated or shredded cheese according to claim 35, further comprising an added anti-caking agent in an amount of less than 0.5 wt. % relative to the weight of the cheese.

37. The grated or shredded cheese according to claim 35, packaged in a container that contains between 100 g and 25 kg of the grated or shredded cheese.

38. A method of (i) reducing or preventing sticking or lumping together of grated or shredded cheese, or (ii) reducing or preventing sticking together of stacked cheese slices, the method comprising preparing the cheese from a starter culture comprising a strain of Lactococcus lactis subsp. and a strain of Streptococcus thermophilus capable of producing polysaccharides, wherein the cheese is of the semi-hard or hard type.
